(19) United States
(12) Patent Application Publication
(10) Pub. No.: US 2014/0245593 A1
(43) Pub. Date: Sep. 4, 2014

(54) MANUFACTURING METHOD OF A NON-STICK COOKING VESSEL FOR FOOD, SUCH AS A COOKING POT OR SIMILAR ARTICLE, INTERNALLY PROVIDED WITH CERAMIC COATING

(71) Applicant: Michele Montagna, (US)

(72) Inventor: Michele MONTAGNA, Pesaro (IT)

(73) Assignee: ALLUFLON S.P.A., Pesaro (IT)

(21) Appl. No.: 13/783,886

(22) Filed: Mar. 4, 2013

(51) Int. Cl. B23P 17/04

(52) U.S. Cl. CPC B23P 17/04
USPC 29/527.1

(57) ABSTRACT

A manufacturing method of a non-stick cooking vessel for food, such as a cooking pot or similar article, internally provided with ceramic coating, comprising the following steps: (a) preparation of a flat metal substrate; (b) heating of said substrate at a temperature between 50° C. and 80° C.; (c) application of a ceramic coating of SOL-GEL type in liquid form on at least one first side of said substrate; (d) drying of said coating at approximately 70°±10° C. for approximately 6 to 8 minutes; (e) spin-forming of said substrate in the final shape of said cooking vessel; and (f) polymerization of said ceramic coating.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application relates to a manufacturing method of a non-stick cooking vessel for food, such as a cooking pot or similar article, internally provided with ceramic coating.

2. Description of Related. Art Including information Disclosed Under 37 CFR 1.97 and 37 CFR 1.98.

In the state of the art, it is known to internally apply a non-stick coating layer in a cooking vessel for food in order to prevent food from sticking to the walls of the vessel during cooking.

According to a known technique, said vessels (which are typically provided with a concave shape) are manufactured starting from a metal disk, such as aluminum, which is first spin-formed and then internally sprayed with one or more PTFE layers.

In spite of being effective, such a technique is impaired by the time that is necessary to paint the vessel after manufacturing.

As a matter of fact, it is intuitively evident that such a painting operation is more difficult and longer when performed on the spin-formed vessel than on the flat metal disk that is the original piece used to manufacture such a vessel.

Painting techniques on flat surfaces have progressed so much that the application of coating is more convenient economically and guarantees higher productive capacity with respect to painting performed on formed items.

As far as painting on flat substrates is concerned, roll coating and curtain coating techniques allow for achieving even higher speed rates with respect to the application of coating with spraying.

A particularly interesting coating layer is a nano-technological ceramic product obtained with a SOL-GEL technique.

The characteristics of such a coating will be discussed in further detail in the description below.

Similarly to the foregoing example with PTFE, the ceramic coating is normally applied inside the cooking vessel with spraying after spin-forming the metal disk (for example aluminum) into the desired shape.

This is necessary because the characteristics of the ceramic coating are such that the high fragility of said material does not allow for deformation of the support substrate where said coating is applied and then polymerized (by means of temperature).

Also in such a case, therefore, the reasons for manufacturing the vessel b spin-forming the metal disk first and then applying the ceramic coating are basically the same as the PTFE coating; moreover, the fact that the SOL-GEL coating is especially rigid discourages any other possibility that provides for deformation of the substrate where the coating is applied.

EP 1 080 806 discloses a method for the production of a non-stick cooking vessel, whereby the internal surface of the substrate of the vessel is treated with a non stick coating prior to forming the coated substrate. Through this, a better integrity of the coating is obtained, i.e. the coating is not subjected to cracking or damage trough the shaping step.

U.S. Pat. No. 4,607,512 discloses a process for manufacturing a cooking vessel, wherein a vessel is formed applying an enamel coating in a central part of a disc blank. A non-stick coating based on a fluorinated polymer is applied to both faces of the enameled disc blank.

WO2007/104258 discloses a non-stick ceramic coating composition for cookware prepared from organic-inorganic hybrid materials, including silica sol, MTMS, FAS and PDMS using sol-gel process.

WO2010/23294 discloses a cooking vessel processing method which involves forming a base-coating layer over a base and a printing layer over the base coating layer.

### BRIEF SUMMARY OF THE INVENTION

The purpose of the present invention is to overcome such a manufacturing method of cooking vessels, which provides for application of the non-stick layer necessarily after spin-forming.

The object of the present invention is a manufacturing method of a non-stick cooking vessel for food, such as cooking pot or similar article, internally provided with ceramic coating, according to the first attached claim.

Further advantageous characteristics are the object of the dependent claims, which are to be intended as an integral part of the present description.

### DETAILED DESCRIPTION OF THE INVENTION

Going back to the coating used for the manufacturing method of cooking vessels according to the present invention, said coating consists in a nano-technological ceramic product made with a SOL-GEL technique.

It is a hybrid organic-inorganic product that combines the non-stick and chemical resistance properties of an organic coating with the excellent hardness and thermal behavior of a coating made of inorganic ceramic material and is extremely suitable to come in contact with food.

Such a coating is of so-called “nano-technological” type and is made according to the “SOL-GEL” technique: it forms, aggregates and grows directly on the support starting from nanometric particles (10-9 m, one millionth of a millimeter), unlike traditional glazed enamel that is generated from powders with dimensions thousands of times higher that melt to form a vitreous film.

Such a coating is obtained starting from an organic liquid in alcoholic solution, called “SOL” that, after some chemical reactions, after being sprayed on the piece and baked in the oven, is first converted into a “GEL” and then becomes ceramic, with alcohol evaporation.

The reactions of the SOL-GEL technique are known to an expert of the field, and are therefore briefly mentioned in this description.

The term “SOL-GEL” indicates a colloidal suspension able to solidify by forming a gel that is then heated to form oxides with high purity.

Such a technique is known and used for production of ceramics, fabrication of parts by casting, production of aerogel and very thin coatings of metal oxides.

The SOL is composed o f sol id particles with diameter of few hundreds of nanometers, usually metal inorganic salts, silicon in this case, suspended in liquid phase.

In a typical sol-gel process, starting from a colloidal suspension (SOL), a series of hydrolysis and polymerization reactions bring the particles to a new phase, called GEL.

The general scheme of the reactions of the SOL-GEL technique, which cause the formation of coating, is shown below:

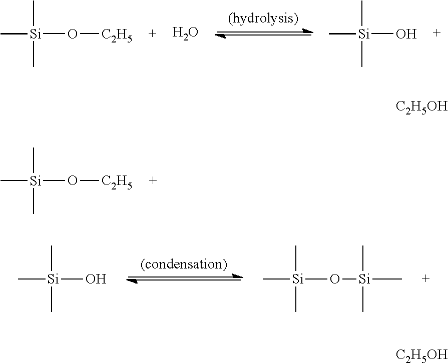

The coating material is a silicate (and therefore ceramic type coating) with the following characteristics:

non-stick: coating is characterized by high compactness, absence of porosity and high surface hydrophobicity;

high temperature resistance: coating does not decompose and is not damaged if exposed to high temperatures for a long time, moreover, even in case of overheating, it does not generate fumes, and resists excellently to thermal shocks;

adhesion and scratch resistance: coating adheres on any type of aluminum provided with suitable roughness profile or other metal material chosen to make the bottom and the coat, and resists excellently to scratches;

chemical resistance: coating resists to washing with soap also in a dishwasher at high temperature and to salt corrosion test;

resistance to abrasion: coating resists to traditional abrasion tests.

An additional advantage of such a material is that it polymerizes in drying oven at 200° C., thus reducing energy costs and limiting carbon dioxide (CO2) in the environment.

The idea of the present invention is to apply the ceramic coating to the flat metal substrate, in liquid form, and dry it at a temperature of 70°±10° C.

In such a way coating does not polymerize until a final complete reticulation status and preservers relative elasticity so that it can follow the bending of the base material on which it is applied, without cracking or damaging.

Moreover, partial reticulation following to said heating superficially forms a highly resistant film with good non-stick properties, which can resist the mechanical stress typical of spin-forming

So, the coating of the invention can be applied to a metal disk that will be subsequently spin-formed, thus overcoming the problems of the methods known at the state of the art.

Complete polymerization, which is necessary for the coating to have the aforementioned typical characterstics that originate from complete reticulation, is obtained after forming, through passage in baking oven at the temperature known for such type of materials.

The manufacturing method of the present invention for production of such a cooking vessel, in a basic shape, comprises at least the following operations:

(a) preparation of a metal disk;

(b) heating of said metal disk at a temperature comprised between 50° C. and 80° C.;

(c) application of a ceramic coating of SOL-GEL type in liquid form on at least one side of said metal disk;

(d) drying of said coating at approximately 70°±10° C. for approximately 6 to 8 minutes;

(e) spin-forming of said disk in the final shape of said cooking vessel; and
(f) polymerization of said ceramic coating.

Preferably, heating operation (b) of said substrate is performed at a temperature comprised between 60° C. and 70° C.

If the vessel is designed to have the external walls provided with coating, additional operations can be provided on the external side of the disk, that is the side adapted to be the external surface of the vessel, such as:

(a1) preparation of an external side of said disk by means of sanding;

(a2) application of an additional coating on said external side of the disk;
(a3) fixing by cooking of the disk of said additional coating.

Operations (a1), (a2) and (a3) are preferably performed before said operation (b).

In some different versions, operation (c) is preceded by the preparation of the internal side, where the ceramic coating of SOL-GEL type in liquid form is applied.

Such preparation is the same as operation (a1) for preparation of the external side of the disk and provides for:

(a1) preparation of an internal side of said disk by means of sanding.

Referring to operations (a2) and (c) for application of a coating, being either the additional one of operation (a2) (adapted to be applied on the external surface of the vessel) and the one of SOL-GEL type in liquid form (adapted to be applied cm the internal surface of the vessel), the application method is one of the known methods for application on flat surfaces, such as roll coating, curtain coating, or spraying in one or more lasers according to the required thickness.

Obviously, modifications can be provided in the aforementioned method relevant the addition of special operations (silk-screening decoration, buffer decoration or other types of decoration in addition to finishing layers); moreover although reference has been made to a metal disk, such a flat metal substrate may also have a different shape, such as rectangular, oval or similar shape, corresponding to vessels with shapes other than cylindrical, such as for example rectangular baking trays, dripping pans or similar articles.

1. A method of manufacturing a non-stick cooking vessel for food, such as a cooking pot or similar article, internally provided with ceramic coating, comprising at least the following steps:
(a) preparation of a flat metal substrate.
(b) heating of said substrate at a temperature between 50° C. and 80° C.;
(c) application of a ceramic coating of SOL-GEL type in liquid form on at least one first side of said substrate;
(d) drying of said coating at 70°±10° C. for a time between 10 and 8 minutes;
(e) spin forming of said substrate in the final shape of said cooking vessel; and
(f) polymerization of said ceramic coating.

2. Method as claimed in claim 1, also comprising the following steps:
(a1) preparation of a second side of said substrate by means of sanding;
(a2) application of an additional coating on said second side;
(a3) fixing of said additional coating by beating said substrate, said steps (a1), (a2) and (a3) being preferably performed before said step (b).

3. Method as claimed in claim 1, also comprising the following step:
(b2) preparation of said first side by means of sanding; said step (b2) being performed before said step (c).

4. Method as claimed in claim 1, wherein said step for application of coating comprise one or more roll coating or curtain coating or spraying operations.

5. Method as claimed in claim 1, wherein said heating step (b) of said substrate is performed at a temperature between 60° C. and 70° C.
